(19) United States
(12) Patent Application Publication
(10) Pub. No.: US 2002/0093153 A1
(43) Pub. Date: Jul. 18, 2002

(54) Axle stabilization system

(76) Inventors: Michael J. Scotese, Carlisle, PA (US); Steve K. Yates, Scotland, PA (US); Stanley J. Simpson, San Antonio, TX (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/760,177

(22) Filed: Jan. 15, 2001

(51) Int. Cl. B60G 9/02

(52) U.S. Cl. 280/6.153; 280/124.112

(57) ABSTRACT

A stabilization and leveling system for an industrial vehicle of a type comprising a frame and at least one axle which is pivotally connected to the frame. The system comprises a linear actuator pivotally connected between the frame and the axle. The linear actuator includes a lock mechanism and a lock override system. The linear actuator is freely extendable and retractable when the lock mechanism is in a non-actuated condition, such that the axle is freely tiltable relative to the frame, and locked against free extension and retraction upon actuation of the lock mechanism, thereby preventing free movement of the linear actuator and resultant free tilting of the axle relative to the frame. The lock override system is actuable to override the lock mechanism to extend or retract the linear actuator to permit controlled tilt of the axle when it is locked.

### BACKGROUND

The present invention relates to an axle stabilization system for an industrial vehicle. More particularly, the present invention relates to an axle stabilization and leveling system for an industrial vehicle having a frame pivotally mounted on an axle such that the axle is tiltable relative to the frame.

In many industrial vehicles, for example, forklifts, telescopic material handlers, cranes, and excavators, the vehicle frame is typically pivotally mounted to at least one of its axles such that those axles are tiltable relative to the frame. One of the axles, typically the front axle, is either fixed relative to the frame or pivotal with a controlled leveling system associated therewith to allow an operator to controllably level the frame relative to that axle. Such a leveling system generally includes at least one hydraulic cylinder connected to the vehicle hydraulic system and positioned between the frame and the front axle. The operator commands extension or retraction of the cylinder to controllably tilt the axle and thereby level the frame. The hydraulic cylinder does not permit any free movement and only extends or retracts in response to operator commands.

As for the other axle, typically the rear axle, it has generally been allowed to freely pivot and thereby tilt in response to ground contours or centrifugal forces during turning to provide the vehicle with greater comfort and driving stability. However, under various use or loading conditions, the rear axle tilting may cause the vehicle to become less stable.

The prior art discloses the use of various rear axle stabilizer systems that include one or more lockable hydraulic cylinders connected to the vehicle hydraulic system and positioned between the frame and the rear axle. The cylinders are generally open to allow free cylinder movement and corresponding free axle tilt. However, in response to various operating conditions, one or both cylinders are locked to rigidly fix the connection between the frame and the rear axle thereby eliminating free tilting. For example, U.S. Pat. Nos. 4,393,959 (Acker), 4,705,295 (Fought), 6,129,368 (Ishikawa), and 6,131,918 (Chino) each disclose systems including two hydraulic cylinders, one on each side of the pivot joint. Ishikawa further discloses a system utilizing a single hydraulic cylinder. In each of these prior art designs, once a predetermined condition is detected, the cylinders lock to rigidly fix the position of the axle. If the operator attempts to level the front of the vehicle using the leveling system while the rear axle is locked, the leveling command may be prevented, the vehicle may contort front to rear, or one of the rear tires may lift off the ground due to the rigidity of the rear axle.

### SUMMARY

The present invention relates to a stabilization and leveling system for an industrial vehicle of a type comprising a frame and at least one axle which is pivotally connected to the frame such that it is tiltable relative to the frame. The stabilization system comprises a linear actuator pivotally connected between the frame and the axle. The linear actuator includes a lock mechanism and a lock override system. The linear actuator is freely extendable and retractable when the lock mechanism is in a non-actuated condition, such that the axle is freely tiltable relative to the frame, and locked against free extension and retraction upon actuation of the lock mechanism, thereby preventing free movement of the linear actuator and resultant free tilting of the axle relative to the frame. The lock override system is actuable to override the lock mechanism to extend or retract the linear actuator to permit controlled tilt of the axle when it is locked. The linear actuator is preferably self-contained such that it is independent of the vehicle hydraulic supply, thereby allowing easier installation, particularly in field installations, and reduces the actuator's susceptibility to failure based on malfunction of the vehicle hydraulic system.

The stabilization system further comprises a sensor system, configured to sense one or more vehicle parameters, and a controller. The controller is associated with the sensor system, the lock mechanism, and the lock override system and is configured to actuate the lock mechanism upon receipt of a signal from the sensor system indicating a predetermined vehicle parameter condition exists. The controller is also configured to actuate the lock override system upon receipt of a command to actuate such.

### BRIEF DESCRIPTION OF THE DRAWING FIGURES

FIG. 1 is a side elevation of an illustrative industrial vehicle.

FIG. 2 is a rear elevation of an illustrative axle and frame assembly incorporating a linear actuator in accordance with the present invention.

FIG. 3 is plan view in partial section of a preferred embodiment of the linear actuator of the present invention.

FIG. 4 is a schematic representation of the linear actuator of FIG. 3 associated with a control system.

FIG. 5 is a schematic representation of the linear actuator of FIG. 3 in a free flow condition.

FIG. 6 is a schematic representation of the linear actuator of FIG. 3 in a closed flow condition.

FIG. 7 is a schematic representation of the linear actuator of FIG. 3 in a leveling bypass condition.

FIG. 8 is a side elevation of the industrial vehicle of FIG. 1 with its boom elevated.

### DETAILED DESCRIPTION OF THE PREFERRED EMBODIMENTS

The preferred embodiments of the present invention will now be described with reference to the drawing figures where like numerals represent like elements throughout. Reference to orientation, for example, front, rear, left, right, is to provide descriptive clarity only and is not intended to be limiting. The present invention may be utilized in conjunction with either vehicle axle and on either side of the vehicle.

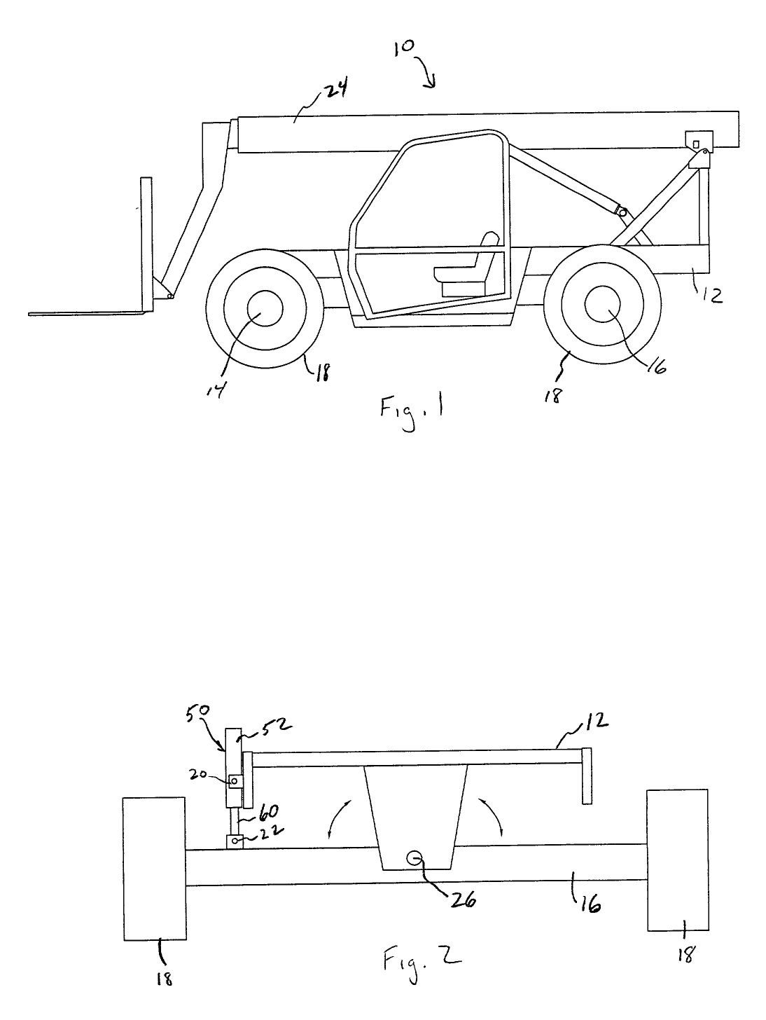

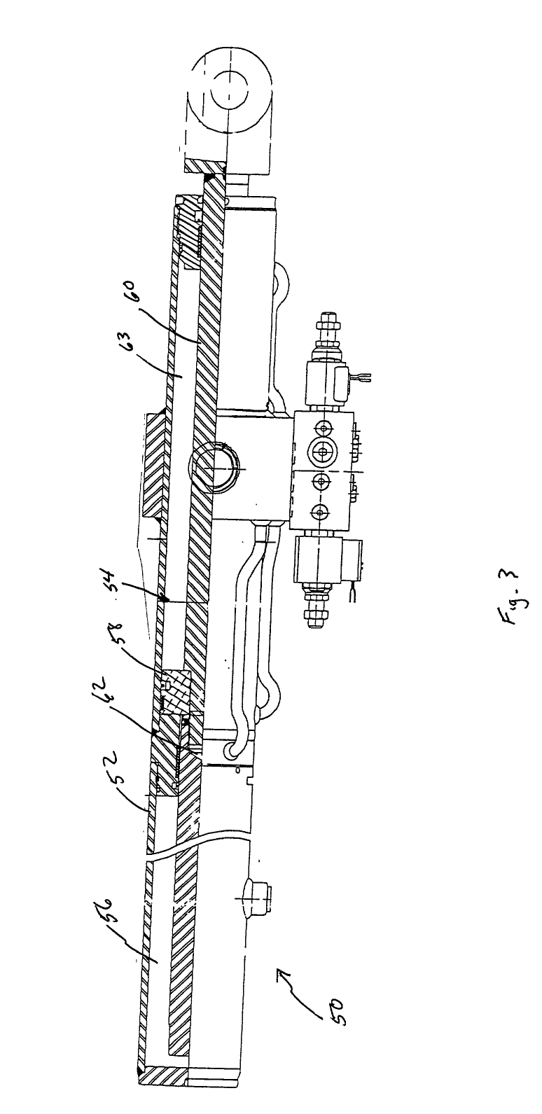

Referring to FIGS. 1 and 2, an illustrative industrial vehicle 10 is shown. The vehicle 10 generally comprises a frame 12 pivotally connected to front and rear axles 14, 16 at respective pivot unions 26. The pivot unions 26 allow the axles 14, 16 to tilt relative to the frame 12 as indicated by the arrows in FIG. 2. The illustrated vehicle 10 is of a type having a telescoping material handling boom 24, but the present invention may be utilized in conjunction with other types of vehicles. A controlled leveling system (not shown) may be associated with the front axle 14. The linear actuator 50 of the present invention is pivotally mounted between the frame 12 and rear axle 16 at pivot points 20 and 22. As explained above, the distinction between front and rear is immaterial to the present invention. The controlled leveling system could be associated with the rear axle 16 and the linear actuator 50 of the present invention associated with the front axle 14. However, since the controlled leveling system is typically associated with the front axle 14, such orientation is utilized hereinafter to simplify the description.

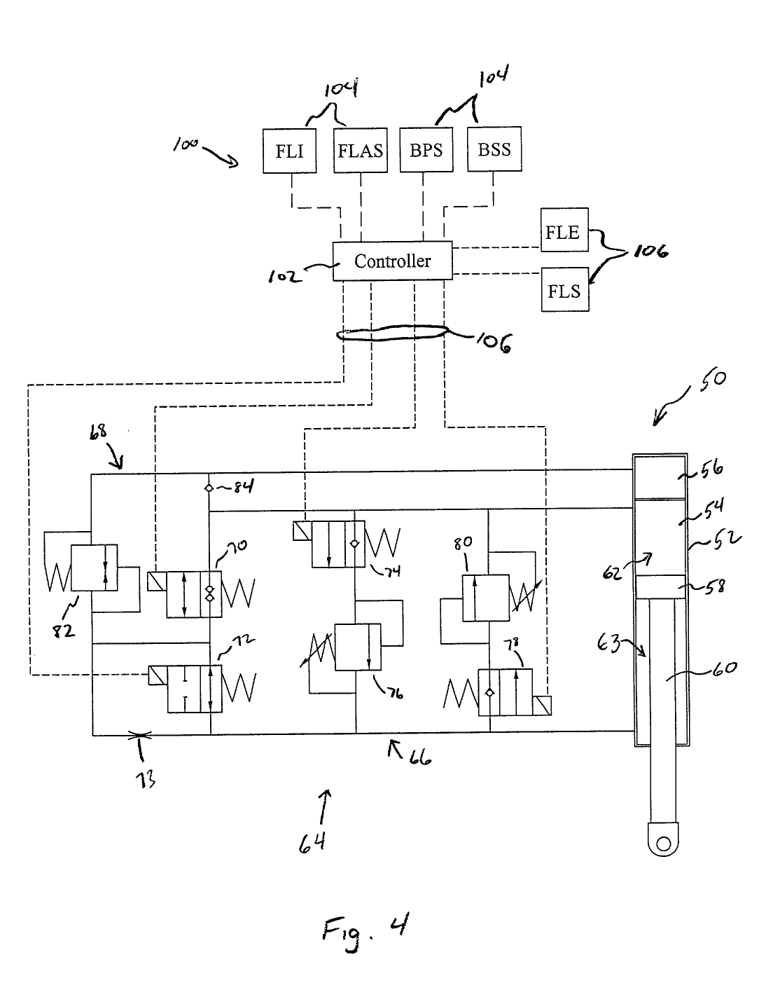

Referring to FIGS. 3 and 4, the preferred linear actuator 50 is a fluid actuator, for example, a hydraulic actuator. The preferred actuator 50 comprises a cylinder 52 having a primary fluid housing 54 and a reservoir chamber 56. A moveable piston 58 is positioned in the primary fluid housing 54 such that it defines first and second chambers 62 and 63. A piston rod 60 connected to and moveable with the piston 58 extends from the cylinder 52. A closed fluid loop 64 provides fluid passage between the chambers 56, 62 and 63. A primary fluid loop 66 interconnects the first and second chambers 62 and 63 and a secondary fluid loop 68 interconnects the primary fluid loop 66 with the reservoir chamber 56.

Operation of the closed fluid loop 64 of the preferred linear actuator 50 will be described with reference to FIG. 4. Extension and retraction of the piston rod 60 are generally controlled via the primary fluid housing 54 and primary fluid loop 66. The reservoir chamber 56 and the secondary fluid loop 68 provide a backup system. The secondary loop 68 is interconnected with the primary fluid loop 66 via a pressure relief valve 82 and a check valve 84. The pressure relief valve 82 is configured such that it will allow fluid flow from the primary loop 66 to the reservoir chamber 56 only upon the existence of a predetermined, generally undesirably high level of pressure in the primary loop 66. The check valve 84 is configured such that it will only allow fluid to flow from the receiver chamber 56 to the primary loop 66 upon the existence of a predetermined, generally low level of pressure, for example, a vacuum condition, in the primary loop 66. As such, under normal operating conditions, the primary loop 66 operates independent of the secondary loop 68 and reservoir chamber 56. As such, if desired, for example, if reliability is less of a consideration, the linear actuator 50 could be made without the reservoir chamber 56 and secondary loop 68. Alternatively, although it is preferred that the linear actuator 50 be self contained, the reservoir chamber 56 and secondary loop 68 could be replaced by the vehicle's hydraulic system to provide the desired backup system.

The primary loop 66 preferably includes a plurality of valves 70-80 which control fluid flow through the loop 66 and thereby control actuation of the linear actuator 50. Lock valve 70 is a bi-direction valve which allows fluid to freely flow in both directions between the first and second chambers 62 and 63. A suitable valve is the Sterling Solenoid Cartridge Valve, 10.4 ohm coil, 14 watts @ 12 vdc. The preferred embodiment includes two oppositely directing uni-directional leveling valves 74 and 78, which are generally closed to fluid flow, positioned in the primary loop 66. Suitable valves are Hydra-Force Solenoid Cartridge Valves, 9.8 ohm coil, 15 watts @ 12 vdc. With the leveling valves 74, 78 generally closed to fluid flow, the lock valve 70 controls general fluid flow through the loop 66. When the lock valve 70 is open to fluid flow, as illustrated in FIG. 5, fluid is free to flow between the first and second chambers 62 and 63. This allows free movement of the piston 58 and piston rod 60 and thereby free tilting of the axle (not shown). When the lock valve 70 is closed to fluid flow, fluid generally cannot flow between the first and second chambers 62 and 63, and therefore, the piston 58 and piston rod 60 are fixed, thereby locking the axle (not shown). If lock override is not desired, for example, if the vehicle does not include a front controlled leveling system, the leveling valves may be omitted.

A throttle 73 and restrictor valve 72 are preferably included in the loop 66 to reduce the likelihood of a sudden fluid flow upon opening of the lock valve 70. A suitable restrictor valve is a Hydra-Force Solenoid Cartridge Valve, 9.8 ohm coil, 15 watts @ 12 vdc. The restrictor valve 72 is generally open to fluid flow such that fluid generally flows unrestricted through the lock valve 70. However, the control system 100 (not shown) is configured to close the restrictor valve 72 to fluid flow for a given amount of time, for example, five seconds, when the lock valve 70 is opened. With the restrictor valve 72 closed, fluid encounters the throttle 73, thereby restricting flow for the given time to allow the loop 66 to normalize.

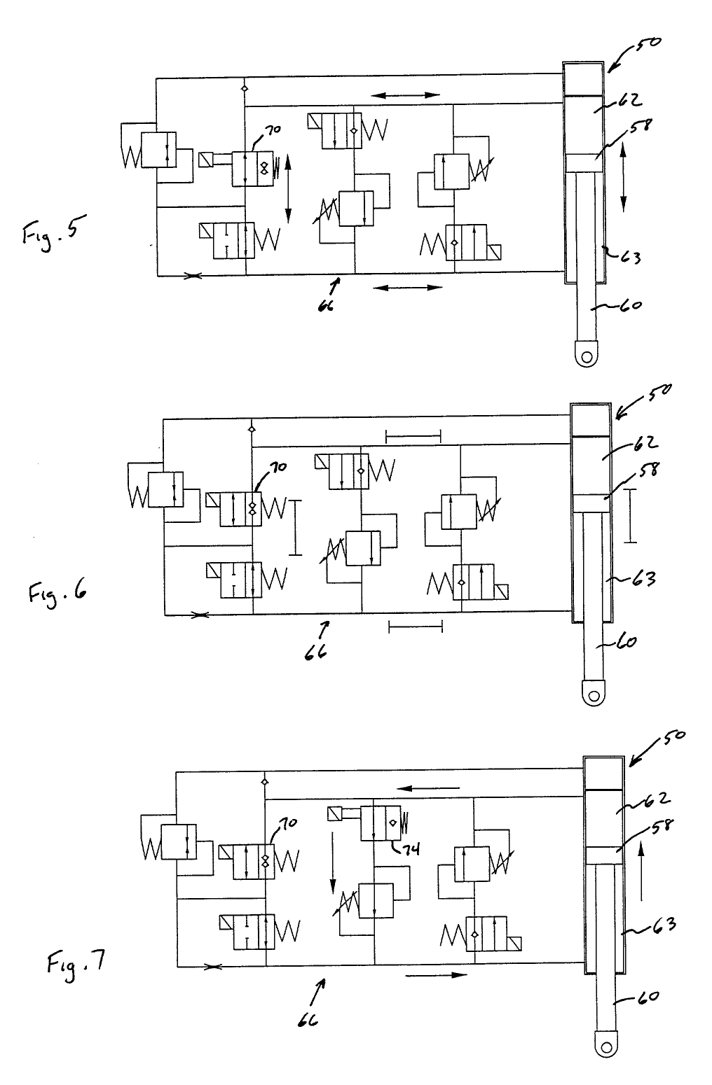

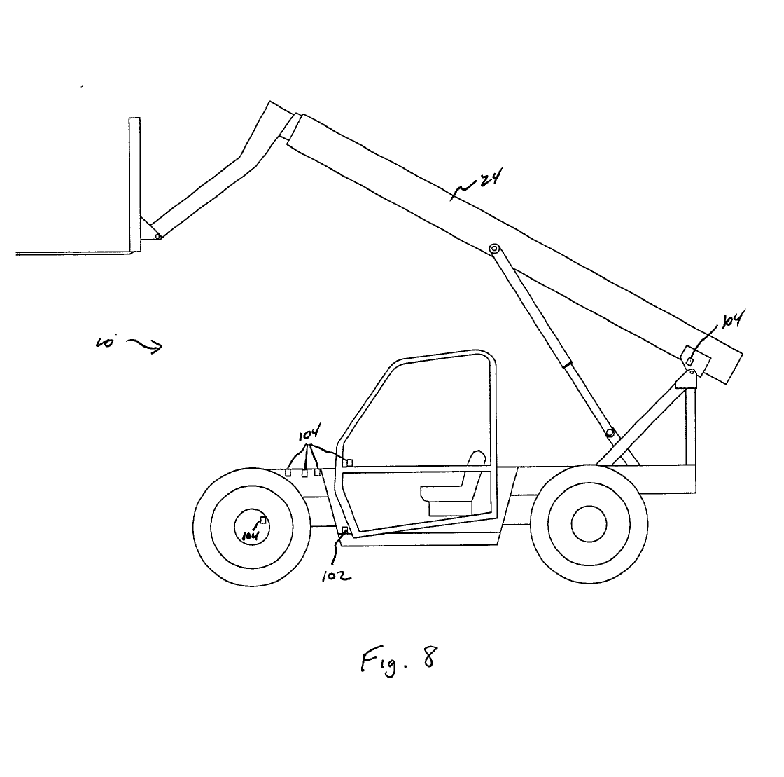

Referring to FIG. 4, each leveling valve 74, 78 provides a controllable, uni-directional bypass in the primary loop 66. As such, each leveling valve 74, 78 permits controllable overriding of the lock valve 70. As illustrated in FIG. 7, one of the leveling valves 74, 78 may be actuated to open a one-way fluid path between the chambers 62 and 63 even though the lock valve 70 is closed to fluid flow. In the illustrated example, leveling valve 74 is actuated to allow fluid to flow from chamber 62 to chamber 63. The resultant change in fluid pressure in this example causes the piston 58 and rod 60 to retract. With the actuator 50 positioned as shown in FIG. 2, the retraction would cause the frame 12 to level from right to left with respect to the axle 16. Each leveling valve 74, 78 preferably has an associated pressure relief valve 76, 80. Each relief valve 76, 80 is configured to prevent flow through its bypass loop until the pressure in that bypass loop reaches a minimum value. As such, the relief valve 76, 80 creates fluid resistance to leveling for more controlled leveling.

While the preferred linear actuator 50 is a fluid actuator, other actuators, including mechanical actuators, may be used. For example, the actuator could include a notched rod engaged by a toothed wheel. The wheel would be generally free rotating, but would be locked against free rotation to lock the actuator. The wheel could then be driven in a desired direction to overcome the locked condition. Alternatively, the rod could be driven by a lockable, driveable belt arrangement.

Referring to FIGS. 4 and 8, interaction between the linear actuator 50 and vehicle operation will be explained in further detail. The vehicle is provided with a control system 100 which preferably includes a controller 102 and a plurality inputs 104 and outputs 106. The inputs 104 are preferably associated with various vehicle components and provide the controller 102 with a plurality of signals indicating various vehicle parameters or operator commands. The controller 102 processes the signals and sends necessary outputs 106 to control the various components of the linear actuator 50. As illustrated, the controller 102 may also send output commands to other vehicle components, for example the front axle frame level enable control (FLE) or the front axle frame level speed control (FLS). In such a manner, the linear actuator 50 leveling function can be coordinated with the front frame leveling system.

In the preferred embodiment, the inputs 104 include: a boom position sensor (BPS), configured to sense whether the boom 24 is positioned within a given range; a brake system sensor (BSS) configured to sense whether the park brake or service brake is applied; a frame attitude sensor (FAS) configured to determine the extent the frame 12 is tilting to the left or to the right; and a frame level input (FLI) configured to receive commands from the operator to level the frame 12 left or right. In the preferred embodiment, the controller 102 is configured to actuate the lock valve 70 upon receipt of a signal that the boom 24 is positioned within the given range and also a signal that one of the brakes is applied. The controller 102 is further configured to actuate the respective leveling valve 74, 78 upon receipt of a frame level command, provided the frame 12 is not already tilting beyond a given angle in the commanded direction. Although the frame leveling valves 74, 78 in the preferred embodiment will not have an impact when the lock valve 70 is open, the controller 102 can be configured to address such. For example, the controller may be configured to: not send a leveling command unless the lock valve 70 is closed; send the leveling command irrespective of the lock valve 70 condition, realizing that the leveling valve 74, 78 will not impact on the linear actuator if the lock valve 70 is open; or lock the lock valve 70 upon receipt of the leveling command.

The above controller inputs and outputs are only illustrative of the preferred control configuration. It is understood that numerous inputs, including and in addition to the above, may be chosen as well as numerous permutations as to the controller output.

What is claimed is:

1. A fluid actuator for use in an axle stabilization system, the actuator comprising:
a housing including a primary fluid chamber;
a piston positioned in and bisecting the primary fluid chamber to define first and second fluid sub-chambers;
a rod extending from the piston out of the housing;
a fluid loop interconnecting the first and second sub-chambers;
a primary bi-directional valve positioned along the fluid loop and operational between an open position wherein fluid flows freely between the sub-chambers and a closed position wherein free, bi-directional flow between the chambers is prevented; and
a uni-directional valve positioned along the fluid loop and actuable to open a bypass loop within the fluid loop to permit uni-directional fluid flow from the first sub-chamber to the second sub-chamber.

2. The actuator of claim 1 further comprising a pressure relief valve associated with the uni-directional valve such that a fluid resistance is provided along the bypass loop.

3. The actuator of claim further 1 comprising a second uni-directional valve positioned along the fluid loop and actuable to open a second bypass loop within the fluid loop to permit uni-directional fluid flow from the second sub-chamber to the first sub-chamber.

4. The actuator of claim 3 further comprising a pressure relief valve associated with each uni-directional valve such that a fluid resistance is provided along each bypass loop.

5. The actuator of claim further 1 comprising a restrictor valve and throttle associated with the primary valve and configured to cause fluid to flow through the throttle for a given amount of time when the primary valve is opened.

6. The actuator of claim 1 wherein the housing further comprises a reservoir chamber which is in fluid communication with the fluid loop via a secondary loop.

7. The actuator of claim 6 wherein the secondary loop and fluid loop are interconnected via a pressure relief valve and a check valve.

8. The actuator of claim 6 wherein the secondary loop and fluid loop define a closed loop between the reservoir chamber and the primary chamber.

9. A fluid actuator for use in an axle stabilization system, the actuator comprising:
a housing having first and second ends with a wall therebetween, the wall bisecting the housing to define a primary fluid chamber and a reservoir fluid chamber;
a piston positioned in and bisecting the primary fluid chamber to define first and second fluid sub-chambers;
a rod extending from the piston out of the housing;
a closed fluid loop interconnecting the first sub-chamber, second sub-chamber and the reservoir; and
a control mechanism positioned along the closed fluid loop and configured to control the flow of fluid between the chambers.

10. The actuator of claim 9 wherein the closed fluid loop includes a primary fluid loop fluidly interconnecting the first and second sub-chambers and a secondary fluid loop interconnecting the primary fluid loop and the reservoir chamber.

11. The actuator of claim 10 wherein the secondary loop and primary loop are interconnected via a pressure relief valve and a check valve.

12. The actuator of claim 10 wherein the control mechanism includes a primary bi-directional valve positioned along the primary loop and operational between an open position wherein fluid flows freely between the sub-chambers and a closed position wherein free, bi-directional flow between the sub-chambers is prevented.

13. The actuator of claim 12 wherein the control mechanism further includes a uni-directional valve positioned along the fluid loop and actuable to open a bypass loop within the fluid loop to permit uni-directional fluid flow from the first sub-chamber to the second sub-chamber.

14. The actuator of claim 13 further comprising a pressure relief valve associated with the uni-directional valve such that a fluid resistance is provided along the bypass loop.

15. The actuator of claim 13 further comprising a second uni-directional valve positioned along the fluid loop and actuable to open a second bypass loop within the fluid loop to permit uni-directional fluid flow from the second sub-chamber to the first sub-chamber.

16. The actuator of claim 15 further comprising a pressure relief valve associated with each uni-directional valve such that a fluid resistance is provided along each bypass loop.

17. The actuator of claim 12 further comprising a restrictor valve and throttle associated with the primary valve and configured to cause fluid to flow through the throttle for a given amount of time when the primary valve is opened.

18. A stabilization and leveling system for a vehicle comprising a frame and at least one axle which is pivotally connected to the frame such that it is tiltable relative to the frame, the stabilization and leveling system comprising;
a linear actuator pivotally connected between the frame and the axle and including a lock mechanism and a lock override system, the linear actuator being freely extendable and retractable when the lock mechanism is in a non-actuated condition, such that the axle is freely tiltable relative to the frame, and the linear actuator being locked against free extension and retraction upon actuation of the lock mechanism, thereby preventing free movement of the linear actuator and resultant free tilting of the axle relative to the frame, the lock override system being actuable to override the lock mechanism to extend or retract the linear actuator to permit controlled tilt of the axle; and
a controller associated with the lock mechanism and the lock override system, the controller configured to actuate the lock mechanism in response to a predetermined condition and further configured to actuate the lock override system upon receipt of a command to actuate the lock override system.

19. The system of claim 18 wherein the actuator is a fluid actuator comprising first and second chambers and the lock mechanism is a valve which controls bi-directional flow between the chambers and the lock override system includes two oppositely uni-directional valves, each operable to open a bypass loop to permit uni-directional fluid flow from one of the chambers to the other.

20. The system of claim 19 wherein the fluid actuator is a self-contained, closed fluid circuit.

21. The system of claim 18 further comprising an input system configured to input various vehicle operating parameters and operator commands to the controller which assist the controller in determining output commands for control of the linear actuator.

22. The system of claim 21 wherein one of the input vehicle parameters is the side to side attitude of the vehicle frame and wherein the controller is configured to prevent override of the actuator to tilt the frame in a given direction if the frame attitude in the given direction is beyond a predetermined value.

23. A stabilization and leveling system for an industrial vehicle comprising a frame and at least one axle which is pivotally connected to the frame such that it is tiltable relative to the frame, the stabilization and leveling system comprising;
a fluid linear actuator pivotally connected between the frame and the axle and including a lock valve and first and second direction leveling valves, the actuator being freely extendable and retractable when the lock valve is in an open condition, such that the axle is freely tiltable relative to the frame, and locked against free extension and retraction upon closing of the lock valve, thereby preventing free movement of the actuator and resultant free tilting of the axle relative to the frame, the first and second direction leveling valves being actuable to override the lock valve to extend or retract the actuator to permit controlled tilt of the axle;
a controller associated with the lock and leveling valves, the controller configured to close the lock valve in response to a predetermined condition and to actuate the appropriate leveling valve upon receipt of a command to actuate such.

24. The system of claim 23 wherein the fluid actuator is a self-contained, closed fluid circuit.

25. The system of claim 23 further comprising an input system configured to input various vehicle operating parameters and operator commands to the controller which assist the controller in determining output commands for control of the linear actuator.

26. The system of claim 25 wherein one of the input vehicle parameters is the side to side attitude of the vehicle frame and wherein the controller is configured to prevent override of the actuator to tilt the frame in a given direction if the frame attitude in the given direction is beyond a predetermined value.
